(19) United States
(12) Patent Application Publication
(10) Pub. No.: US 2008/0285512 A1
(43) Pub. Date: Nov. 20, 2008

(54) METHOD AND APPARATUS FOR REDUCING MODULATION, CODING AND TRANSPORT BLOCK INFORMATION SIGNALING OVERHEAD

(75) Inventors: Kyle Jung-Lin Pan, Smithtown, NY (US); Guodong Zhang, Farmingdale, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/113,791

(22) Filed: May 1, 2008

Related U.S. Application Data
(60) Provisional application No. 60/915,135, filed on May 1, 2007.

(51) Int. Cl. H04Q 7/00

(52) U.S. Cl. 370/329

(57) ABSTRACT

A method and apparatus for reducing modulation and coding scheme (MCS) signaling overhead includes receiving a channel quality indicator (CQI) feedback. It is determined if there is a CQI feedback error. An MCS indicator is transmitted based upon the CQI feedback error determination.

### CROSS REFERENCE TO RELATED APPLICATIONS

This application claims the benefit of U.S. Provisional Application No. 60/915,135, filed May 1, 2007, which is incorporated by reference as if fully set forth.

### FIELD OF INVENTION

This application is related to wireless communications.

### BACKGROUND

In a wireless communication system, signaling overhead can result in transmission inefficiencies and non-optimal utilization of available bandwidth. An evolved Node-B (eNB) may utilize channel quality indicator (CQI) feedback received from a wireless transmit/receive unit (WTRU) in order to determine a modulation and coding scheme (MCS) to use for transmission.

A WTRU typically reports CQIs to the eNB. The CQI is an index to an entry of a CQI table representing an MCS. The eNB receives reported CQIs from the WTRU and makes a decision about the corresponding proper modulation and coding scheme that should be used according to these reported CQIs. Once the MCS is selected, the eNB uses the corresponding MCS to perform adaptive modulation and coding (AMC) in downlink transmissions. In order for the WTRU to perform data detection correctly, the MCS used at the eNB should be known to the WTRU. One way to accomplish this is to send the full information about MCS to the WTRU via a physical downlink control channel (PDCCH). When the MCS table size is large, a large number of bits are required to represent an MCS. Furthermore, when multiple-in multiple-out (MIMO) is used, information for multiple MCSs for multiple spatial data streams or multiple codewords may be required to be signaled to the WTRU.

It would be beneficial to provide a method and apparatus for reducing MCS signaling overhead.

### SUMMARY

A method and apparatus for reducing the signaling overhead for modulation and coding scheme (MCS) and/or transport block set or size (TBS) information is disclosed. The method includes receiving a channel quality indicator (CQI) feedback. It is determined whether or not there is a CQI feedback error (or whether or not a CQI feedback is reliable). An MCS indicator is transmitted based upon the CQI feedback error or reliability determination. MCS indicator may indicate the confirmation to the WTRU's feedback. MCS indicator may also indicate the MCS information or TBS information.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of WTRUs and an eNB;

FIG. 2 is an example functional block diagram of a WTRU and the eNB of FIG. 1;

FIG. 3 is a flow diagram of a method of reducing signaling overhead;

FIG. 4 is an example frame format for reducing signaling overhead;

FIG. 5 is an alternative example frame format for reducing signaling overhead; and

FIG. 6 is a flow diagram of a method for indicating MCS/TBS information.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

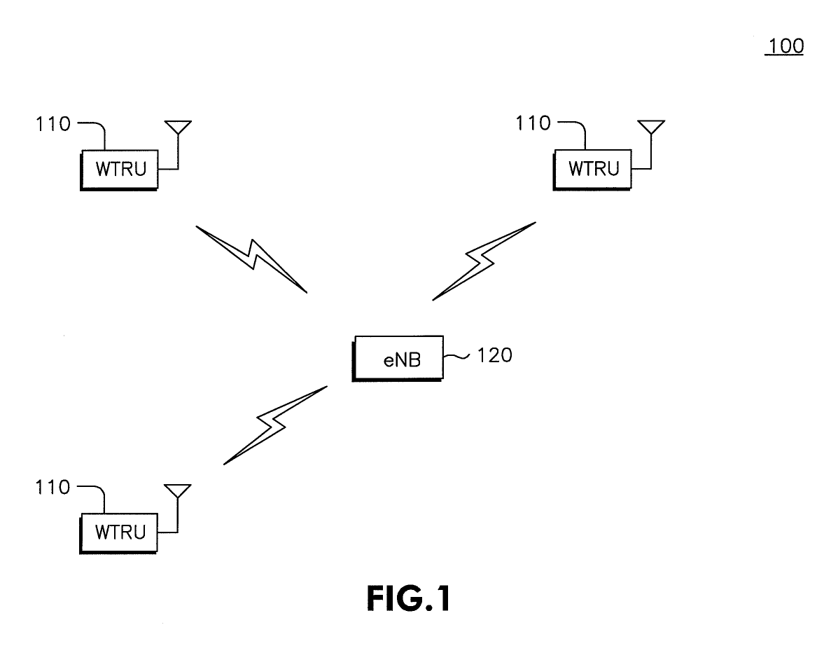

FIG. 1 shows an example wireless communication system 100 including a plurality of WTRUs 110 and an eNB 120. As shown in FIG. 1, the WTRUs 110 are in communication with the eNB 120. It should be noted that, although an example configuration of WTRUs 110 and eNB 120 is depicted in FIG. 1, any combination of wireless and wired devices may be included in the wireless communication system 100.

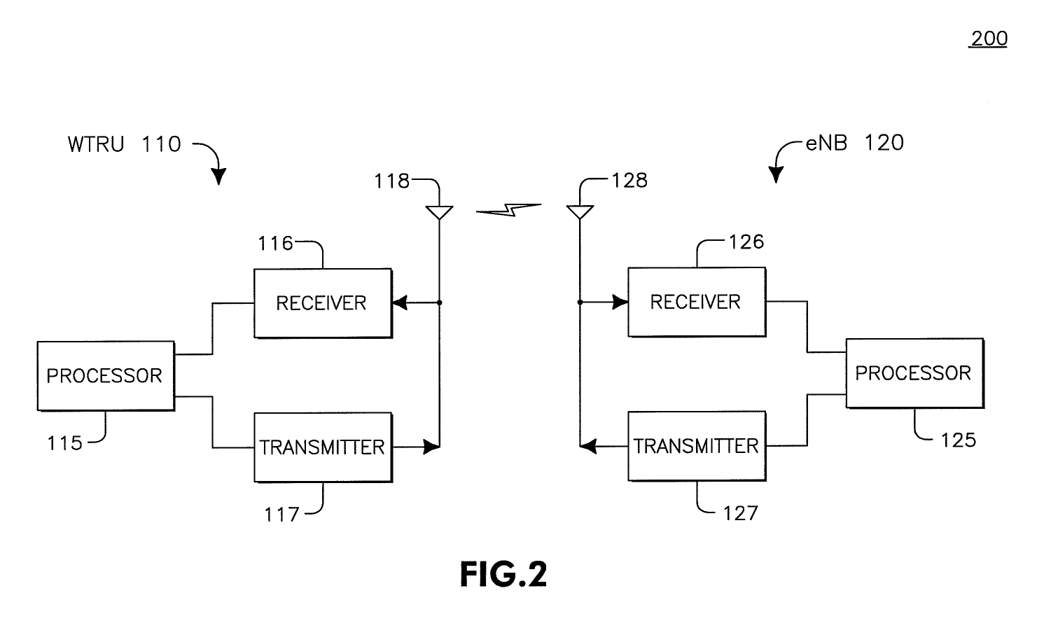

FIG. 2 is an example functional block diagram 200 of a WTRU 110 and the eNB 120 of the wireless communication system 100 of FIG. 1. As shown in FIG. 2, the WTRU 110 is in communication with the eNB 120. The eNB 120 is configured to receive CQI feedback information from the WTRU 110 and signal an MCS to the WTRU.

In addition to the components that may be found in a typical WTRU, the WTRU 110 includes a processor 115, a receiver 116, a transmitter 117, and an antenna 118. The receiver 116 and the transmitter 117 are in communication with the processor 115. The antenna 118 is in communication with both the receiver 116 and the transmitter 117 to facilitate the transmission and reception of wireless data. The processor 115 of the WTRU 110 is configured to transmit CQI feedback to the eNB 120, such as via transmitter 117, and is configured to receive an MCS from the eNB 120, such as via the receiver 116.

In addition to the components that may be found in a typical eNB, the eNB 120 includes a processor 125, a receiver 126, a transmitter 127, and an antenna 128. The receiver 126 and the transmitter 127 are in communication with the processor 125. The antenna 128 is in communication with both the receiver 126 and the transmitter 127 to facilitate the transmission and reception of wireless data. The processor 125 of the eNB 120 is configured to receive a CQI feedback from a WTRU 110, such as via the receiver 126, and is configured to transmit an MCS indicator to the WTRUs 110, such as via the transmitter 127.

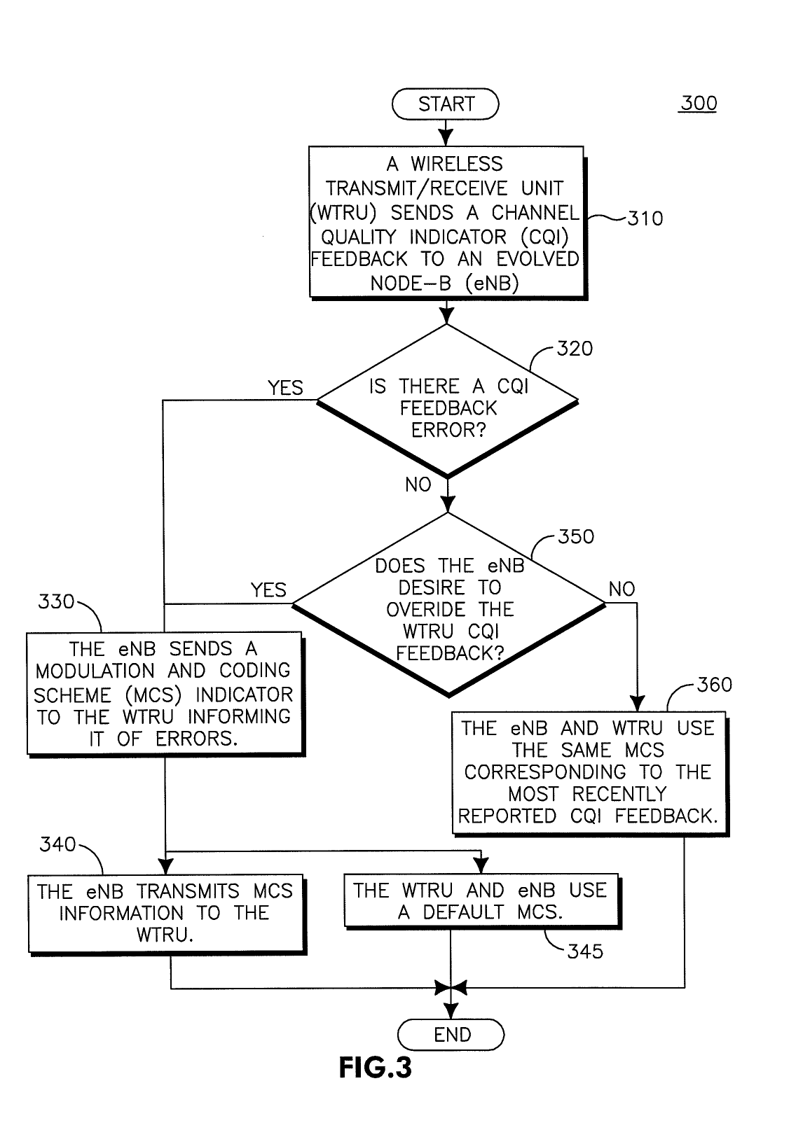

FIG. 3 is a method of reducing signaling overhead 300. In step 310, a WTRU 110 sends a CQI feedback to the eNB 120, which may be a single CQI feedback or multiple CQI feedbacks. The eNB 120 receives the CQI feedback and determines whether or not the CQI feedback is correct and reliable. Nominally, the CQI block error rate is about one to ten percent (1-10%), meaning that approximately ninety to ninety-nine percent (90-99%) of the time, the CQIs are received correctly. If there is no CQI feedback error (step 320), and if the eNB does not desire to override the WTRU 110 CQI feedback (step 350), then the WTRU 110 and the eNB 120 utilize the same MCS that corresponds to the most recently reported CQI that was fed back from the WTRU 110 (step 360). The eNB 120 transmits an MCS indicator to the WTRU 110 indicating to the WTRU 110 that the eNB 120 is utilizing the same CQI feedback.

A one (1)-bit indicator may be embedded in a downlink (DL) scheduling grant, (e.g., within PDCCH), or transmitted independently to the WTRU 110, that will alert the WTRU 110 that the same MCS and/or transport block size (TBS) that corresponds to the most recently reported CQI that was fed back from the WTRU 110 is to be used. No actual MCS and/or TBS information is required to be sent from the eNB 120 to the WTRU 110. The MCS indicator may be a single indicator utilized for multiple codewords, or multiple MCS indicators may be utilized, such as one for each codeword.

If a CQI feedback error was detected in step 320, the CQI feedback was unreliable, or the eNB 120 desires to override the WTRU CQI feedback in step 350, then the eNB 120 sends an MCS indicator to the WTRU 110 informing it of errors (step 330). Additionally, the eNB 120 may send the MCS and/or TBS information (step 340), (e.g., payload, modulation). If any two of the payload, modulation, and coding rate are known, then the third one may be derived. For example, in order to determine the TBS, the number of resource blocks (RBs) along with the modulation, coding rate or payload size should be known. The number of RBs that may be assigned to the WTRU 110 may be signaled to WTRU 110 via a control channel, (e.g., via PDCCH). Each RB may consist of M resource elements (REs). The MCS can indicate how many information bits are carried by, for example, W bits per RE. If there are N RBs assigned to the WTRU 110, then the TBS will be approximately N×M×W bits. The payload size may indicate a TBS corresponding to an assigned number of RBs or a payload size per RB.

Alternatively, the eNB 120 and the WTRU 110 may utilize a default MCS and/or TBS (step 345). The default MCS and/or TBS may be predefined and known to both the WTRU 110 and the eNB 120. The default MCS and/or TBS may be used when there is a negative confirmation that may be due to an override or when there is a feedback error. Previously used MCS and/or TBS information may also be used if there is a feedback error provided the previously used MCS and/or TBS information is still valid.

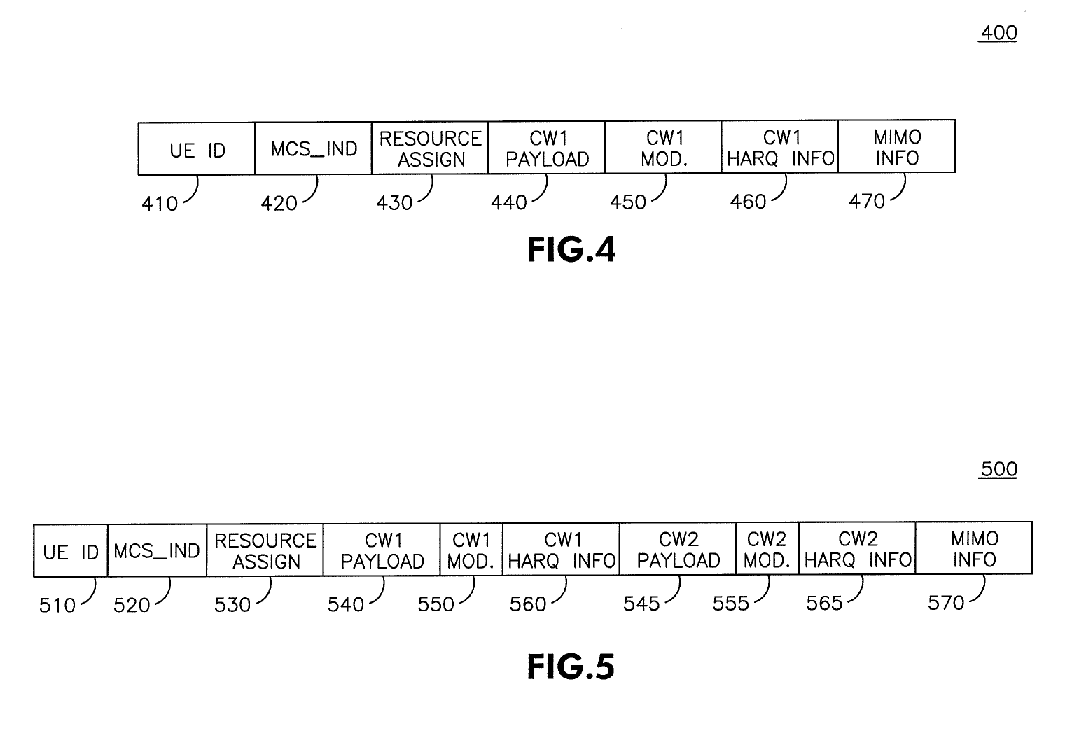

FIG. 4 is an example frame format 400 for reducing signaling overhead. The frame format 400 includes a UE ID field 410, an MCS indicator (MCS_IND) field 420, a resource assignment (Assign) field 430, a codeword (CW) 1 payload field 440, a CW1 Modulation (Mod) field 450, a CW1 hybrid automatic repeat request (HARQ) info field 460, and a multiple-in multiple-out (MIMO) info field 470. The resource assignment field 430 may indicate a number of RBs assigned and their locations. The CW1 modulation field 450 may indicate the modulation order for codeword 1. The CW1 HARQ info field 460 may include HARQ parameters such as incremental redundancy version (RV) and new data indicator (NDI). The MIMO info field 470 may include MIMO information such as rank, precoding, and the like. For purposes of example, the frame format 400 may be utilized in quadrature phase shift keying (QPSK), 1/3. Additionally, the CW1 payload and CW1 MOD fields can be combined into one single field to indicate a TBS that contains modulation and coding information for a given number of RBs.

It should be noted that the fields depicted in the example frame format 400 are for example purposes. Some fields may not need to be present in the example frame format 400 and some fields may be combined. For example, the codeword (CW) 1 payload field 440 and CW1 Modulation (Mod) field 450 may not be needed and may be eliminated from format 400. Alternatively, the codeword (CW) 1 payload field 440 and CW1 Modulation (Mod) field 450 may be combined together, or also into the MCS indicator field 420. That is, the MCS indicator field 420 may include the codeword (CW) 1 payload field 440 and the CW1 Modulation (Mod) field 450 in a single field with the same or different, (e.g., reduced) number of bits.

The MCS indicator field 420 may include one value, such as “zero” (0) as an MCS confirmation, (i.e., a positive-confirmation message), to indicate that the MCS and/or TBS used at the eNB 120 and the WTRU 110 are identical and where there is no CQI feedback error and/or desire by the eNB 120 to override the WTRU 110 CQI feedback. The MCS indicator field may include a second value, such as a “one” (1) as a negative confirmation message to indicate that the MCS and/or TBS used at the eNB 120 and the WTRU 110 are not identical, such as when there is a CQI feedback error or there is a desire by the eNB 120 to override the WTRU 110 CQI feedback. For example, the eNB 120 may override the WTRU 110 CQI feedback for scheduling reasons or because of a network issue.

FIG. 5 is an example frame format 500 for reducing signaling overhead. The frame format 500 includes a UE ID field 510, an MCS_IND field 520, a resource assignment (Assign) field 530, a CW1 payload field 540, a CW1 Mod field 550, a CW1 HARQ info field 460, a CW2 payload field 545, a CW2 Mod field 555, a CW2 HARQ info field 565, and a MIMO info field 570.

It should be noted that the fields depicted in the example frame format 400 are for example purposes. Some fields may not need to be present in the example frame format 500 and some fields may be combined. The CW1 payload field 540 and CW1 Mod field 550 may be combined into a single filed to indicate a first codeword TBS that contains modulation and coding information for a given number of RBs. The CW2 payload field 545 and CW2 Mod field 555 may be combined into a single field to indicate a second codeword TBS that contains modulation and coding information for a given number of RBs. For purposes of example, the frame format 500 may be utilized in QPSK, 1/2. The fields of example frame format 500 are substantially similar in purpose to those of example frame format 400.

Accordingly, signal overhead may be reduced significantly. For example, assuming the CQI feedback block error rate is 1%, 1 bit is utilized for the eNB 120 to confirm the MCS to the WTRU 110 and 5 bits are utilized for the eNB 120 to transmit the MCS to the WTRU 110 for adaptive modulation and control (AMC). For a single codeword, and for every 100 downlink (DL) MCS information messages corresponding to the 100 uplink (UL) CQI feedbacks, using DL MCS indicator signaling, the signaling overhead for downlink is D=99×1+1×(1+5)=105 bits per 100 DL MCS information messages. In this case, the MCS indicator uses one bit for the WTRU's feedback to be confirmed.

The signaling overhead for downlink without an MCS indicator is D=100×5=500 bits per 100 DL MCS information messages. Accordingly, the MCS signaling overhead is reduced by approximately 80% for a single codeword. More reductions occur for double or multiple codewords schemes that have two or more codewords.

In the examples described previously, the MCS indicator may use 1 bit for MCS confirmation, where a “0” indicates positive confirmation message and “1” indicates a negative confirmation message. Additional bits may be used for the MCS indicator for indicating the MCS information message. That is, additional bits may be used for an indication of MCS and/or TBS information. For example, four bits, such as “0000”-“1111”, may indicate MCS and/or TBS information, for example, 16 kinds of MCS and /or TBS information for modulation and coding rates, (e.g., MCS#1 to MCS#16). In this case, an MCS indicator with both confirmation and information messages, one plus additional bits, may be used and transmitted.

A corresponding example format for this scenario may be derived from the example frame format 400 of FIG. 4. That is that the CW1 Payload field 440 and CW1 MOD field 450 are combined into the MCS indicator field 420 in format 400 in FIG. 4. The MCS indicator field 420 contains the information of the CW1 Payload field 440 and CW1 MOD field 450. Accordingly, the CW1 Payload field 440 and CW1 MOD field 450 may not be needed and may be removed in format 400.

If additional bits are not used for MCS and/or TBS information messages, (e.g., the WTRU 110 and/or eNB 120 is using default MCS and/or TBS information), then the MCS indicator may operate only as a confirmation message, either positive or negative. Only the MCS indicator with the confirmation message, (i.e., one bit), is transmitted.

A corresponding example format for this scenario may also be derived from the example frame format 400 of FIG. 4. The CW1 Payload field 440 and CW1 MOD field may be eliminated from frame format 400 in FIG. 4. The MCS_IND field 420 then contains the confirmation message.

If additional bits for MCS and/or TBS information messages are not used when a positive confirmation message is indicated, the MCS indicator with a confirmation message, (i.e., one bit), is transmitted if a positive confirmation is indicated and an MCS indicator with both confirmation and information messages, (i.e., one plus additional bits), is transmitted if a negative confirmation is indicated.

A corresponding example format, (i.e., positive confirmation format), for the above scenario with relation to the example frame format 400 is that the CW1 Payload field 440 and CW1 MOD field 450 may be eliminated from frame format 400 in FIG. 4. The MCS indicator field 420 is used to indicate a confirmation message for MCS and/or TBS for the WTRU's feedback. Another corresponding example format, (i.e., negative confirmation format), for this scenario is that the CW1 Payload field 440 and CW1 MOD field 450 are not eliminated but combined into the MCS indicator field 420 in format 400 in FIG. 4. The MCS indicator field 420 contains the information of the CW1 Payload field 440 and CW1 MOD field 450. Accordingly the CW1 Payload field 440 and CW1 MOD field may not be needed and may be removed in frame format 400. The MCS indicator field 420 is then used to indicate confirmation and information messages for MCS and/or TBS.

Although the example frame format 400 of FIG. 4 was utilized in the examples described above, similar examples could be derived using the example frame format 500 of FIG. 5.

Alternatively, the MCS indicator may use a bit sequence for combined encoding of MCS confirmation and information.

The MCS indicator field 420 in FIG. 4 or MCS indicator field 520 in FIG. 5 may include one value, such as a “bit sequence 0” as an MCS confirmation to indicate that the MCS and/or TBS used at the eNB 120 and the WTRU 110 are identical and where there is no CQI feedback error and desire by the eNB 120 to override the WTRU 110 CQI feedback. The MCS indicator field may include other values, such as a “bit sequence x” as a combined negative confirmation message and information message to indicate that the MCS and/or TBS used at the eNB 120 and the WTRU 110 are not identical, such as when there is a CQI feedback error or there is a desire by the eNB 120 to override the WTRU 110 CQI feedback. This may also indicate the kind of MCS and/or TBS information that is used at the eNB 120 where x may indicate the kind of MCS and/or TBS information, (e.g., the index to a table containing MCS and/or TBS information).

The MCS indicator field 520 in FIG. 5 may include values to indicate one MCS and/or TBS confirmation message for multiple codewords, (i.e., one confirmation message for all codewords). The MCS indicator field 520 in FIG. 5 may also include values to indicate multiple MCSs and/or TBSs confirmation messages for multiple codewords, (i.e., one confirmation message for each codeword).

For example, the CW1 PAYLOAD 540, CW1 MOD 550, CW2 PAYLOAD 545 and CW2 MOD 555 fields can be removed from the example frame format 500 in FIG. 5. The MCS_IND field 520 may contain a single bit to indicate a confirmation message for all the codewords. The MCS_IND field 520 may also contain multiple bits, (e.g., two bits), to indicate a confirmation messages for all the codewords. For example, a first bit may indicate the confirmation message for the first codeword and a second bit may indicate the confirmation message for the second codeword and so on.

The MCS indicator field 520 in FIG. 5 may include values to indicate one MCS and/or TBS information message for multiple codewords, (i.e., one information message for all codewords). In addition, the MCS indicator field 520 in FIG. 5 may also include values to indicate multiple MCSs and/or TBSs information messages for multiple codewords, (i.e., one information message for each codeword).

For example, the MCS_IND field 520 may contain information in the CW1 PAYLOAD 540, CW1 MOD 550, CW2 PAYLOAD 545 and CW2 MOD 555 fields. Accordingly, the CW1 PAYLOAD 540, CW1 MOD 550, CW2 PAYLOAD 545 and CW2 MOD 555 fields may not be needed and can be removed from the example frame format 500 in FIG. 5. The MCS_IND field 520 may contain a bit sequence to indicate an information message for all the codewords. The MCS_IND field 520 may also contain bit sequences to indicate information messages for multiple codewords, (e.g., a first bit sequence indicates the information message for the first codeword and a second bit sequence indicates the information message for the second codeword and so on). A combined bit sequence, (e.g., by joint encoding) may also be used to indicate information messages for multiple codewords.

Using 5 bits for the MCS indicator as an example, “00000” may indicate an MCS confirmation message that indicates the MCS and/or TBS information used at eNodeB is the same as those fed back from WTRU, and “00001” to “11111” may indicate MCS and/or TBS information messages, for example, 31 kinds of MCS and/or TBS information for modulation and coding rate, and the like, (e.g.,, MCS#1 to MCS#31). In this example, the MCS indicator is a combination of confirmation and information messages for MCS and/or TBS. That is, the MCS and/or TBS confirmation and indication messages are jointly encoded.

For the same number of bits, such as 5 bits, joint encoding of confirmation and information messages for MCS and/or TBS may indicate more MCSs and/or TBS than separate encoding per MCS and/or TBS validation message, or 31 versus 16. On the other hand, separate encoding of MCS and/or TBS confirmation and information messages may allow more efficient signaling by sending only an MCS and/or TBS confirmation bit if the MCS and/or TBS information used at eNodeB is the same as those indicated by the CQI feedback from WTRU. For example, if there is no error, or if the CQI feedback signal is reliable and eNB 120 has no desire to override the WTRU 110's CQI feedback, only a single bit for MCS and/or TBS confirmation is transmitted.

Alternatively, different numbers of bits can be used for separate and joint encoding of MCS and/or TBS confirmation and information messages. To indicate the same number of MCSs and/or TBSs, separate encoding of confirmation and information messages may require one more bit for MCS and/or TBS confirmation purpose than joint encoding per an MCS signaling validation message.

An MCS indicator can also signal additional types of messages, such as confirmation messages, information messages, override messages, and feedback error messages. A confirmation message is used to confirm that the MCS and/or TBS information used at the eNB 120 is the same as the MCS and/or TBS information, (e.g., indicated by CQI), fed back from WTRU 110. An information message is used to indicate the MCS and/or TBS information, such as the kind of MCS and/or TBS that is used at the eNB 120. An override message is used to indicate that the eNB 120 is overriding the WTRU's 110 CQI feedback and a new MCS and/or TBS information, such as an indicated MCS and/or TBS or a default MCS and/or TBS, is used at the eNB 120. A feedback error message is used to indicate the WTRU's 110 CQI feedback is in error and the last used MCS and/or TBS information is used at the eNB 120.

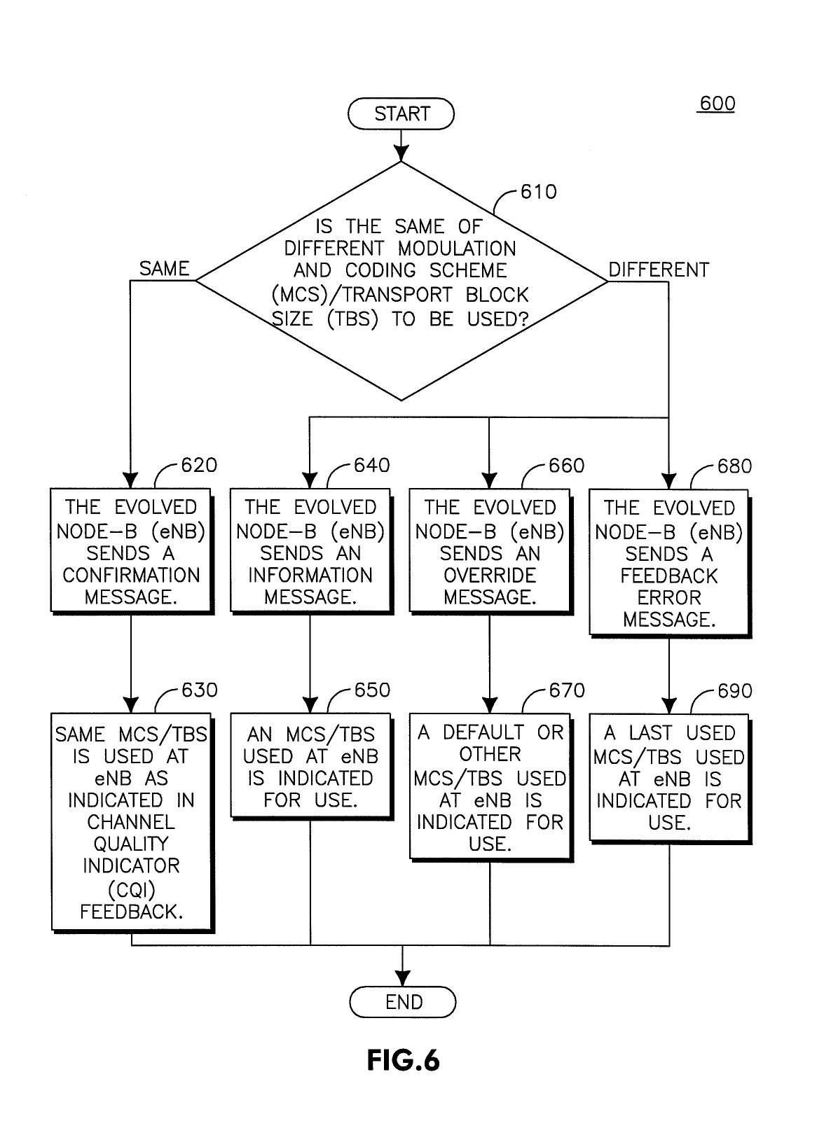

FIG. 6 is a flow diagram of a method 600 for indicating MCS/TBS information. Either a different or the same MCS and/or TBS information may be used corresponding to different messages (step 610).

If the same MCS and/or TBS is to be used, then the eNB 120 sends a confirmation message to the WTRU 110 (step 620). In this case, the same information regarding MCS and/or TBS indicated in CQI feedback from WTRU 110 may be used at the eNB 120 (step 630).

Alternatively, if a different MCS and/or TBS is to be used, then the eNB 120 may send an information message (step 640), an override message (step 660), or a feedback error message (680). When sending and receiving an information message, it indicates that an MCS and/or TBS that is indicated and used by eNB 120 may be used by the WTRU 110 (step 650). When sending and receiving a override message, it indicates that a default MCS and/or TBS or another MCS and/or TBS that is indicated and used at the eNB 120 may be used at the WTRU 110 (step 670). When sending and receiving a feedback error message, it indicates that a last or previous used MCS and/or TBS at the eNB 120 and WTRU 110 may be used at the current time at the eNB 120 and WTRU 110 (step 690). Variants and combinations of these messages and the interpretation of these messages may also be utilized. More types of messages may also be included.

An MCS table at the eNB 120, or transmitter, could be a superset of a CQI/MCS table used at the WTRU 110, or receiver. For example a 16QAM code rate 1/3 and QPSK code rate 2/3 may have the same spectral efficiency. Both a 16QAM code rate 1/3 and QPSK code rate 2/3 may be included in an MCS table at the eNB 120, or transmitter. Additionally, if only the 16QAM code rate 1/3 is included in the CQI/MCS table at the WTRU 110, or receiver, then when the CQI feedback from WTRU 110 indicates a 16QAM code rate 1/3, the eNB 120 may use either the MCS of the 16QAM code rate 1/3 or the MCS of QPSK code rate 2/3.

Depending upon channel conditions one may be more desirable than the other. For example, in AWGN, a QPSK code rate 2/3 may perform better than a 16QAM code rate 1/3. This may reverse when the channel condition is that of a fading channel. While in a fading channel, a 16QAM code rate 1/3 may perform better than the QPSK code rate 2/3. The eNB 120 could measure the channel conditions, (e.g., AWGN, fading, and the like), and decide which modulation and coding rate should be used for optimum performance.

If the eNB 120 in the above example uses the 16QAM code rate 1/3, a confirmation message is sent. However, if the eNB 120 uses the QPSK code rate 2/3, an override message is sent.

Alternatively a confirmation message with an additional bit to indicate either 16QAM code rate 1/3 or QPSK code rate 2/3 may be used at the eNB 120. 16QAM code rate 1/3 or QPSK code rate 2/3 may be treated as a pair. It may use an additional confirmation state, message or an additional information state or message instead of using an additional bit, to indicate the other MCS (QPSK code rate 2/3) of the pair when the feedback is 16QAM 1/3. Using a confirmation message, (e.g., using one bit or a bit sequence or bit combination), may reduce the number of bits to be sent for MCS and/or TBS signaling.

If the eNB 120 uses an MCS other than 16QAM code rate 1/3 or QPSK code rate 2/3, an override message may be sent. If the eNB 120 detects the feedback is not reliable or has error, an error message is sent instead in accordance with step 330 of the method 300 or step 680 of the method 600.

When there are multiple CQIs each corresponding to a particular RB group (RBG) and the eNB 120 schedules downlink transmission on more than one RBG, then the eNB 120 may need to average, or further process, CQIs of these scheduled RBGs to select an appropriate MCS and/or TBS. Depending upon single or multiple codewords, one, two or more sets of MCSs and/or TBS information have to be produced and sent from the eNB 120 to the WTRU 110. In this case, a formula or a mapping table can be used to produce the proper MCS information using CQI feedback. One equation that may be utilized is as follows:

MCS information=f(CQI#1, CQI#2, . . . , CQI#M),

where M is greater or equal to one, f( ) may be a function, formula or mapping table using the proper CQIs for MCS information mapping and generation. A simple f( ) may be a weighted or non-weighted averaging process or may come from a look-up table. An example of f( ) is log-normal average function. Such a function, formula or table should be known to both a transmitter, such as the eNB 120, and a receiver, such as the WTRU 110. It could be either hard coded/wired, stored in memory or signaled to ensure the interpretation for CQIs and MCSs and/or TBS are aligned and correct.

The methods 300 and 600 described above may be applied to uplink communications, downlink communications, or both where applicable, and may be implemented in eNB to WTRU communication, WTRU to eNB communication, or bidirectionally.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for reducing modulation and coding scheme (MCS) signaling overhead, comprising:
receiving a channel quality indicator (CQI) feedback;
determining if there is a CQI feedback error determining if the CQI feedback is reliable; and
transmitting an MCS indicator based upon the CQI feedback error and reliability determinations.

2. The method of claim 1 wherein the MCS indicator is embedded in a downlink (DL) scheduling grant.

3. The method of claim 1 wherein the MCS indicator indicates that the MCS that corresponds to the most recently reported CQI that was fed back is to be utilized.

4. The method of claim 1 wherein the MCS indicator indicates that a CQI feedback error occurred.

5. The method of claim 4, further comprising transmitting MCS information.

6. The method of claim 5 wherein the MCS information includes any one of the following: payload and modulation.

7. The method of claim 1, further comprising determining to override the CQI feedback error determination.

8. The method of claim 7, further comprising transmitting MCS information.

9. The method of claim 8 wherein the MCS information includes any one of the following: payload and modulation.

10. An evolved Node-B (eNB), comprising:
a receiver;
a transmitter; and
a processor in communication with the receiver and the transmitter, the processor configured to receive a channel quality indicator (CQI) feedback from a wireless transmit/receive unit (WTRU), determine if there is a CQI feedback error, and transmit a modulation and coding scheme (MCS) indicator to the WTRU based upon the CQI feedback error determination.

11. The eNB of claim 10 wherein the processor is further configured to embed the MCS indicator in a downlink (DL) scheduling grant.

12. The eNB of claim 10 herein the processor is further configured to transmit MCS information to the WTRU.

13. The eNB of claim 10 wherein the processor is further configured to override the CQI feedback error determination.

14. The eNB of claim 10 wherein the MCS indicator indicates that the MCS that corresponds to the most recently reported CQI that was fed back from the WTRU is to be utilized.

15. A wireless transmit/receive unit (WTRU), comprising:
a receiver;
a transmitter; and
a processor in communication with the receiver and the transmitter, the processor configured to transmit a channel quality indicator (CQI) feedback to an evolved Node-B (eNB), receive a modulation and coding scheme (MCS) indicator from the eNB, and determine whether or not to change the MCS that is being utilized by the WTRU.

16. The WTRU of claim 15 wherein the MCS indicator indicates that the MCS that corresponds to the most recently reported CQI that was fed back from the WTRU is to be utilized.

17. The WTRU of claim 15 wherein the processor is further configured to receive MCS information from the eNB.

18. A method for reducing modulation, coding and transport block signaling overhead, comprising:
receiving a channel quality indicator (CQI) feedback;
determining whether or not to use a same modulation and coding scheme (MCS); and
sending a message based upon the determining of whether or not to use the same MCS.

19. The method of claim 18 wherein if the same MCS is to be used, the message sent is a confirmation message.

20. The method of claim 18 wherein if a different MCS is to be used, the message sent is an information message.

21. The method of claim 20, further comprising indicating an MCS to be used.

22. The method of claim 18 wherein if a different MCS is to be used, the message sent is an override message.

23. The method of claim 20, further comprising indicating a default MCS to be used.

24. The method of claim 18 wherein if a different MCS is to be used, the message sent is a feedback error message.

25. The method of claim 18, further comprising indicating a use of a same MCS.

26. The method of claim 18, further comprising determining whether to use a same transport block size (TBS).
